(19) United States
(12) Patent Application Publication
(10) Pub. No.: US 2005/0276277 A1
(43) Pub. Date: Dec. 15, 2005

(54) Interactive priority discrimination apparatus and method

(76) Inventor: Joshua C. Pace, Salt Lake City, UT (US)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 11/034,959

(22) Filed: Jan. 13, 2005

Related U.S. Application Data
(60) Provisional application No. 60/578,167, filed on Jun. 9, 2004.

(51) Int. Cl. H04J 3/16; H04Q 7/00; H04J 1/16; H04L 1/00; H04L 12/26; H04J 3/14; H04J 3/22

(52) U.S. Cl. 370/465; 370/328; 370/229

(57) ABSTRACT

A method and system forming a buffer or filter between a user and a petitioner seeking access to a user. The method may include providing a database. In the database may be stored names of petitioners. Each name may be coupled to a value selected from a rating scale. Each value may characterize the petitioner to which the corresponding name applies. A processor may receive a request for access or petition (e.g. telephone call, facsimile, e-mail, letter, advertizement, etc.) from the petitioner. Executables operable on the processor may extract a name (e.g. indication of source) from the petition, retrieve from the database the value coupled to the name, and grant privileges to the petitioner according to the value. Petitioners having values high on the rating scale may be given greater privileges that petitioners having values low on the rating scale.

### RELATED APPLICATIONS

This application claims the benefit of co-pending U.S. Provisional Patent Application Ser. No. 60/578,167, filed on Jun. 9, 2004 for RONNI PERSONAL RATING SYSTEM.

### BACKGROUND

1. The Field of the Invention

This invention relates to telephone control hardware and software and, more particularly, to novel systems and methods for programming cellular telephones to communicate rating information to and from a user.

2. The Background Art

A problem recently encountered by many persons is the concept of a “leash” created by an operable cellular telephone on one's person. That is, for example, when an individual is not home, a voice messaging system may so indicate. When a person is not in the office, a receptionist or voice messaging system may so inform a caller. When one is not available by cellular telephone, a voice messaging system may likewise so inform a caller. However, if an individual relies substantially on a cellular telephone, that telephone may be “on.”

An individual may leave a cellular telephone on to receive a call from a key client, a significant other, a child, or another whose message is anxiously awaited. By contrast, a call from a telemarketer, casual acquaintance, or another individual or company may be unwanted or at least untimely. To some extent, caller identification has a certain-capacity to inform an individual as to whether a call is of sufficiently high priority to be taken. Nevertheless, even viewing an incoming number displayed on a ringing telephone and making such an evaluation is itself an interruption.

Thus, it would be a substantial advance in the art to provide a system whereby an individual user of a telephone system (e.g. a cellular telephone system) could rate and filter calls with a quick, straightforward, simple system programmed into a telephone network or individual telephone unit.

Inasmuch as it is highly desirable to return control of telephone access to the owner of the telephone, rating of access privileges from individual numbers or persons need not be limited to incoming calls. That is, once a mechanism is programmed and installed in a telephone network or individual telephone unit in order to submit ratings to a database, that database may store ratings related to a wide variety of subjects.

For example, movies are rated by critics. Movies are also rated by individuals. Sports teams are rated by sports writers and coaches. Likewise, sports teams are rated by individual sports enthusiasts. Radio and television talk shows often broadcast toll free numbers whereby individuals may call and vote on a political, moral, social, or otherwise public issue.

Accordingly, it would be an advance in the art to provide a mechanism whereby a telephone user could submit, in a simple and practical manner, a rating for substantially any business, commercial experience, product, or the like. For example, it would be an advance in the art if a telephone user could walk out of an establishment and submit, with minimal effort, a rating corresponding to any aspect or characteristic of the business desired to be reported. A fine restaurant experience, a miserable restaurant experience, a helpful commercial sales experience, or a frustrating commercial sales experience, all could be articulated in ratings entered into a cellular telephone.

Thus, it would be an advance in the art to provide additional software, hardware, or a combination thereof suitable to support a rating system and receiving inputs from a telephone user related to callers, potential callers, classes of callers, or commercial establishments, experiences, products, and the like.

### BRIEF SUMMARY OF THE INVENTION

In view of the foregoing and in accordance with the invention as embodied and broadly described herein, a method and apparatus are disclosed in one embodiment of the present invention as including a buffer positioned between a user and a petitioner, seeking access to the user. A buffer may provide the mechanism through which a user may exert control over how much access he grants a petitioner at any time. In some embodiments, a buffer, once created, may act substantially automatically to filter and process petitions for access sent by petitioners to the user. In other embodiments, a buffer may act as a resource that a user may consult to educate himself regarding the petitioner. Accordingly, the user's ability to make an informed decision regarding how much, if any, access the user should give to the petitioner may be increased.

A buffer may also provide certain benefits to a petitioner. In selected embodiments, a buffer may become a repository in which the preferences of one or more users are stored and possibly even broadcast or probed. By limiting itself to fit certain criteria and announcing same, or by examining these preferences, a petitioner may better understand and meet the needs and desires of a user. With this increased understanding, the petitioner may better tailor petitions to meet the needs and desires of the user.

One example of an automated, filtering buffer may be a rating system applied to incoming telephone calls. A user may select a value from a rating scale to characterize the importance applied by the user to a particular petitioner. A user may also create a protocol articulating different privileges for the various values on the rating scale. Accordingly, when a rated petitioner calls, the buffer may apply the protocol and grant privileges to the petitioner according to his rating. A petitioner rated on the rating scale may have unlimited, limited, or no access granted. For example, a petitioner having a rating of ten on a one to ten rating scale may ring through at any time, day or night. Alternatively, a petitioner having a rating of one on the one to ten rating scale may never ring through and may never even be granted access to voice mail.

In some embodiments, a user may be given the opportunity to rate a petitioner (e.g. caller) at the end of any call to or from that petitioner. Ratings so collected may be stored and applied automatically the next time that petitioner seeks telephone access to the user. An automated, filtering buffer may be formed using hardware, software, or any combination of hardware and software.

One example of a resource buffer may be a rating system applied by multiple users to a variety of subjects. For example, users may submit, as well as view, ratings on businesses, movies, products, legislation, etc. In general, there is a proponent behind all such subjects. Such proponents may be considered petitioners seeking access to a user in the form of patronage, acceptance, support, etc. Accordingly, ratings related to a subject may assist a user in deciding whether to grant access (e.g. pay money, purchase product, etc.) to a petitioner.

In some embodiments, a resource buffer may include one or more databases receiving, updating, and releasing rating information. Such a database may be hosted on a network (e.g. the Internet) to provide access to the users. The database may be equipped to receive rating information in a variety of ways. For example, rating information may be submitted using a personal computer on the Internet. Rating information may also be submitted using an appropriate application running on the operating system of the user's cellular telephone. Submitting and viewing ratings with a cellular telephone may provide substantially convenience and promote greater utilization of the buffer.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of an embodiment of a buffer in accordance with the present invention interfacing between a user and a petitioner;

FIG. 2 is a schematic block diagram of an embodiment of the components of a buffer in accordance with the present invention;

FIG. 3 is a schematic listing of various protocol variables in accordance with the present invention that may be modified to control access given an incoming telephone call;

FIG. 4 is a schematic diagram of an embodiment of a protocol comprising a rating scale with example privileges assigned to various values thereof in accordance with the present invention;

FIG. 5 is a schematic diagram of an embodiment of a database of a buffer in accordance with the present invention;

FIG. 6 is a schematic diagram of multiple cellular telephones equipped in accordance with the present invention and connected to a common database hosted on the Internet;

FIG. 7 is a schematic diagram of one embodiment of the steps taken within a utilization system to implement a rating scheme and the steps taken within a creation system to create or update the rating scheme in accordance with the present invention;

FIG. 8 is a schematic diagram of an embodiment of the steps taken by a buffer in accordance with the present invention to prompt a user for ratings relating to a petitioner;

FIG. 9 is a schematic block diagram of an alternative embodiment of the components of a buffer in accordance with the present invention;

FIG. 10 is a schematic diagram of an alternative embodiment of the steps taken within a utilization system to implement a rating scheme and the steps taken within a creation system to create or update the rating scheme in accordance with the present invention;

FIG. 11 is a schematic view of a series of possible screens used by an embodiment of a user interface of a buffer in accordance with the present invention; and

FIG. 12 is a schematic block diagram illustrating the inputs and outputs of users and petitioners in one embodiment of a buffer subscription arrangement in accordance with the present invention.

### DETAILED DESCRIPTION OF SELECTED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of the various embodiments of the invention. These embodiments of the invention will be best understood by reference to the drawings, wherein like parts are designated by like numerals throughout.

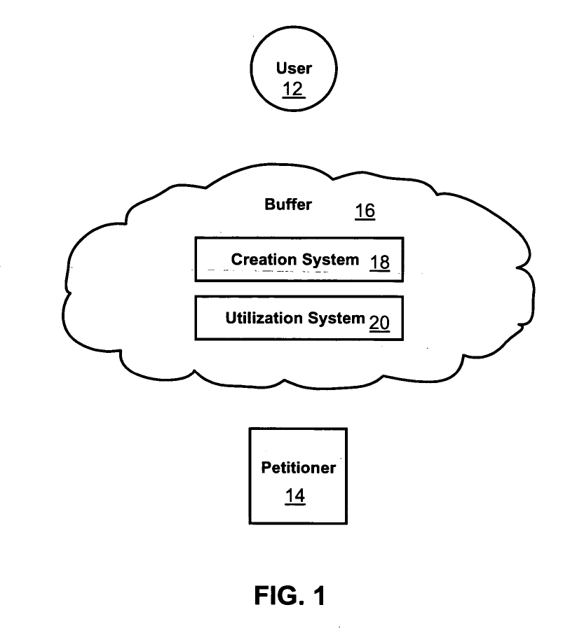

Referring to FIG. 1, in selected embodiments in accordance with the present invention, a system 10 may include a user 12, a petitioner 14, and a buffer 16. A user 12 may be any person or entity (e.g. business entity). A petitioner 14 may be any person or entity seeking access to the user 12. A buffer 16 may be any device, program, system, arrangement, or the like that reduces the shock, damage, annoyance, inconvenience, consumption of resources, etc., caused by contact between the user 12 and the petitioner 14. In general, a buffer 16 may be something that serves as a protective barrier for the user 12.

A petitioner 14 may seek access to a user 12 in a variety of ways. Some methods of seeking access may be direct, while others are passive. For example, methods of pursuing direct access may include personal visits, telephone calls, pages, facsimiles, e-mails, mailings, and the like. Passive methods of pursuing access may include advertisements, commercials, promotions, and the like.

Various factors may determine how eager a user 12 is to grant access to a petitioner 14. Perhaps most determinative is the identity of the petitioner 14. For example, a user 12 may be much more willing to accept a call from his boss than from a telemarketer. Other factors that may influence the eagerness or inclination of the user 12 to grant access to the petitioner 14 may include the time of day, schedule of the user 12, disposition of the user 12, location of the user 12, needs, wants, and interests of the user 12, and the like.

By taking into account the various factors that influence the decision of a user 12 whether to grant access to a petitioner 14, a buffer 16 may improve the position of the user 12 with respect to the petitioner 14. For example, a buffer 16 may provide the mechanism for a user 12 to limit the access given any particular petitioner 14. In some embodiments, a buffer 16 may act automatically “behind to the scenes” to enforce a filtering scheme. A buffer 16 may also provide information to a user 12 about the petitioner 14. With information, a user 12 may be empowered and more beneficially determine how, or if, the user 12 will interact with the petitioner 14.

A buffer 16 may also provide certain benefits to a petitioner 14. That is, by examining a buffer 16 created and made available by a user 12, a petitioner may gain useful insights into the preferences of that user 12. The petitioner 14 may then revise its strategy, product line, etc. to better fit the user 12. Accordingly, a buffer 16 may protect a user 12 while educating a petitioner 14. Likewise, a petitioner may identify itself and its key features to a buffer, thus assuring that its contact will only pass through buffers of interested parties.

In selected embodiments, a buffer 16 may include a creation system 18 and a utilization system 20. In general, a creation system 18 may be any arrangement of hardware, software, or some combination thereof that may be used to create and update rules, parameters, instructions, protocols, etc. intended to protect a user 12, provide information to a petitioner 14, or both. A utilization system 20, on the other hand, may be any arrangement of hardware, software, or some combination thereof that implements the rules, parameters, instructions, protocols, etc.

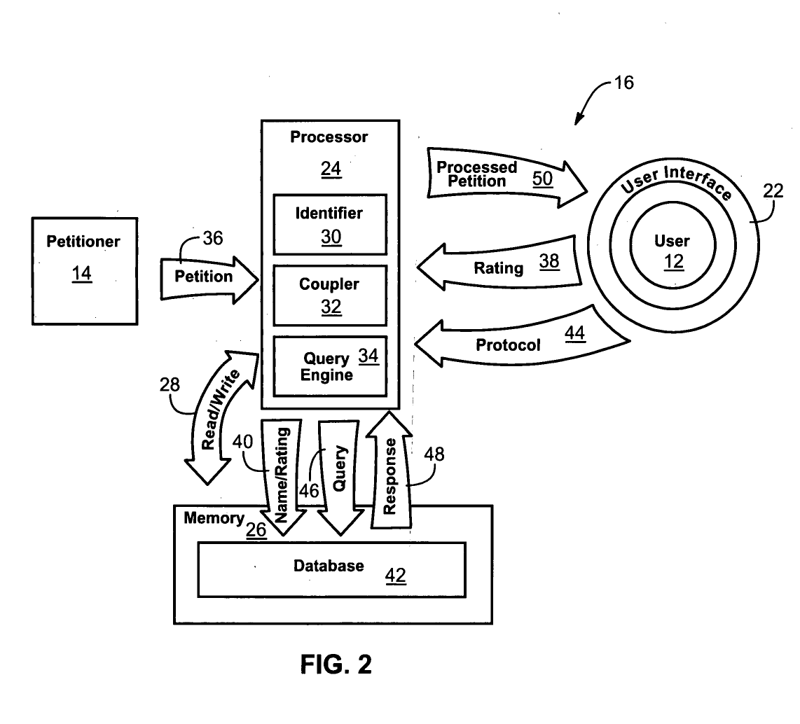

Referring to FIG. 2, in certain embodiments, a buffer 16 may include a user interface 22, processor 24, and memory device 26. A user interface 22 may be any hardware, software, or hardware and software combination that provides communication between a user 12 and a processor 24. In selected embodiments, a user interface 22 may be arranged to communicate information to a user 12 and receive inputs from a user 12. For example, a user interface 22 may be a display coupled with a keyboard, keypad, or pointer (e.g. mouse). In other embodiments, a user interface 22 may be a touch screen.

The complexity of the user interface 22 may depend upon the amount and complexity of the information being presented and inputs being received. In embodiments with minimal communication needs, an interface 22 comprising a simple character display and limited input keys may be adequate. In other embodiments with greater communication needs, an interface 22 such as is provided on a personal computer may be more appropriate.

In certain embodiments, a preexisting user interface 22 may be sufficient to provide the communication contemplated. For example, computers of all sorts (e.g. personal computers, personal digital assistants, cellular telephones, etc.) typically include a user interface 22 providing commination between a user 12 and a processor 24. In some embodiments, the user interface 22 provided with such “computers” may be suitable, without adaption, to manage the communication requirements of systems and methods in accordance with the present invention.

A processor 24 in accordance with the present invention may be any hardware, software, or hardware and software combination that provides processing capability. Similarly, a memory device 26 may be any hardware, software, or hardware and software combination that provides storage capability. In selected embodiments, the processor 24 may have “read” and “write” communication 28 with the memory device 26. Accordingly, instructions stored in a memory device 26 may be executed by a processor 24. Executed instructions may form various modules or configurations designed to perform selected tasks. For example, in certain embodiments, executed instructions may form an identifier 30, coupler 32, and query engine 34.

In selected embodiments, a memory device 26 may be positioned proximate a processor 24. That is, the memory device 26 may be included within the same physical device as the processor 24. For example, both the processor 24 and the memory device 26 may be positioned within a cellular telephone. Alternatively, a portion of the memory device 26 may be positioned remotely from the processor. For example, some portions of a memory device 26 may be available proximate the processor 24 to facilitate execution of routine instructions, while other portions may be positioned remotely (e.g. on a network accessible to the processor 24). Remotely positioned memory 26 may be useful to store large amounts of data, data accessed less often, or data to be shared with other users 12.

In operation, a petitioner 14 may submit a petition 36 to a processor 24. A petition 36 may be any action or communication directed by a petitioner 14 to a user 12. In general, a petition 36 may constitute the request of petitioner 14 for access to, or the attention of, the user 12. In selected embodiments, a petition 36 may be an incoming telephone call. In other embodiments, a petition 36 may be an incoming e-mail. In still other embodiments, a petition 36 may be a facsimile, mailed letter, mailed package, or the like.

An identifier 30 operating within the processor 24 may examine a petition 36 to extract a name or entity identification corresponding to the source of the petition 36 (i.e. the petitioner 14). For example, if the petition 36 is an incoming telephone call or facsimile, an identifier 30 may be a caller identification module extracting the telephone number from which the incoming call or facsimile originates. In such a case, the name of the petitioner 12 may be the telephone number. Alternatively, the name may be the text (e.g. personal name, business name) associated with the telephone number.

In other embodiments, the name extracted may be the e-mail address from which an e-mail originates. In still other embodiments, the name may be a return address or sending information scanned from a letter or package. In general, the name extracted from a petition 36 by an identifier 30 may be any collection or combination of alphabetic text, numeric text, bar codes, etc. that provide a unique identification of the petitioner 14. Accordingly, an identifier 30 may include any hardware or software necessary to extract the name, taking into account the type of petition 36 being received.

When a petition 36 is received, a processor 24 may, through the user interface 22, prompt a user 12 for a rating 38. Accordingly, a user 12, through the user interface 22, may provide a rating 38 corresponding to the petition 36. A coupler 32 may bind or otherwise form an association between the name corresponding to the petition 36 and the rating 38 to form a couple 40 or set 40. Couples 40 may be passed from the processor 24 to the memory device 26 for storage.

In selected embodiments, the memory device 26 may include an organized scheme for storing couples 40. For example, couples 40 may be stored in a database 42 in a manner facilitating rapid retrieval. Such a database 42 may be contained in memory 26 positioned proximately or remotely with respect to the processor 24.

At some time before or after a petition 36 is received by a processor 24, a user 12 may communicate a protocol 44 through the user interface 22 to the processor 24. A protocol 44 may be any arrangement of instructions indicating to the processor 24 how the user 12 desires to process or filter petitions 36. In selected embodiments, the protocol 44 may process petitions 36 according to ratings 38 corresponding the petitioner 14 asserting or sending the petition 36. For example, petitions 36 corresponding to a name coupled to a high rating 38 may be treated differently than petitions 36 corresponding to a name coupled to a low rating 38.

A query engine 34 may facilitate retrieval of information from a database 42. For example, when a petition 36 is received by a processor 24, a query engine may send a query 46 to the database to inquire whether the name corresponding to the petition 36 has a rating 38 associated therewith. The database 42 may return a response 48. In general, the response may include a rating 38 associated with the name, if one exists. Using the information provided in the response 48, the processor 24 may appropriately apply the protocol 44.

Application of the protocol 44 to the petition 36 may produce a processed petition 50 or filtrate 50. In selected embodiments, a processed petition 50 represents the petition 36 filtered according to the identity of the petitioner, time of day, schedule of the user 12, disposition of the user 12, location of the user 12, needs, wants, interests of the user 12, or the like. A processed petition 50 may be passed by the processor 24 to a user 12 through the user interface 22.

User interfaces 22, processors 24, and memory devices 26 in accordance with the present invention may be included within both a creation system 18 and a utilization system 20. That is, a user interface 22, processor 24, and memory device 26 may cooperate to form a creation system 18 that creates and updates rules, parameters, instructions, protocols, etc. intended to protect a user 12, provide information to a petitioner 14, or both. Similarly, a user interface 22, processor 24, and memory device 26 may also cooperate to form a utilization system 20 that implements the rules, parameters, instructions, protocols, etc. However, various sub-components of a user interface 22, processor 24, and memory device 26 may act primarily within one system 18, 20 or the other. For example, a coupler 32 may act primarily within the creation system 18, while a query module 34 may act primarily within the utilization system 20.

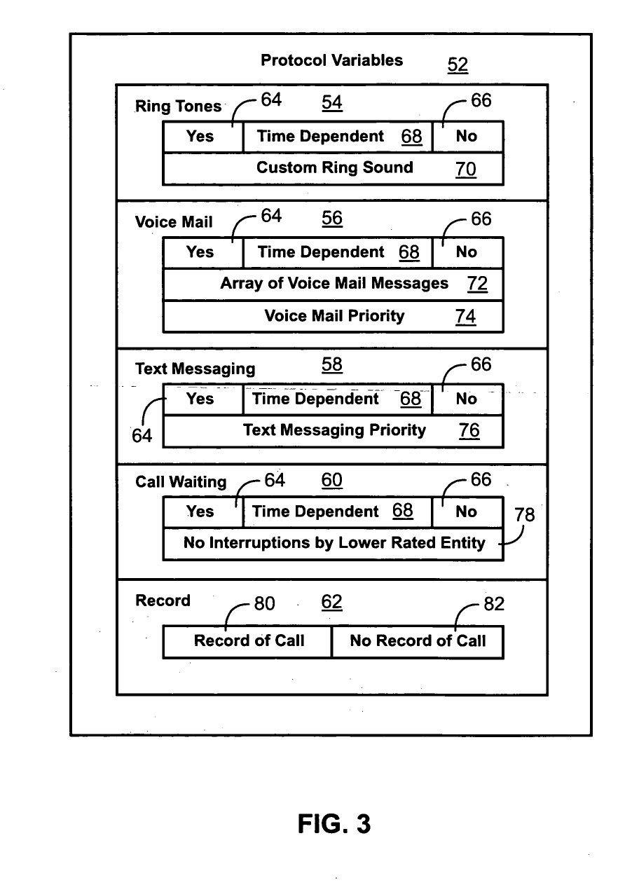

Referring to FIG. 3, protocol variables 52 may define the various filtering options that may be incorporated into a protocol 44 in accordance with the present invention. The protocol variables 52 available may depend largely on the nature of the petition 36. For example, protocol variables 52 available for an incoming letter may be different from protocol variables 52 available for an incoming telephone call. Protocol variables 52 available to an incoming letter may, for example, be represented by various sorting receptacles ranging from a high priority inbox to a trash bin. Similar protocol variables 52 may be applicable to incoming packages, e-mails, and the like. Protocol variables 52 available to an incoming telephone call, on the other hand, may include various options with respect to ring tones 54, voice mail 56, text messaging 58, call waiting 60, record of call 62, and the like.

For illustrative purposes, certain embodiments of protocol variables 52 applicable to incoming telephone calls will be discussed in more detail. Selected protocol variables 52 discussed may have little applicability to petitions 36 other than incoming telephone calls. However, the concepts discussed may have general applicability to a wide range of petitions 36.

In creating a protocol 44, a user 12 may control the ring tones 54 available to petitioners 14 associated with selected ratings 38. For example, a user 12 may select “yes” 64 to grant ring tones 54 or “no” 66 to deny ring tones 54 for particular ratings 38. Additionally, in selected embodiments, a user 12 may select “time dependent” 68 and further specify when during a day, week, etc. selected ratings 38 are met with ring tones 54 and when they are not.

In selected embodiments, a user 12 may customize a ring sound 70 according to rating 38. For example, petitions 36 from petitioners 14 of high rating may be announced with a particular ring sound, while petitions 36 from petitioners of low rating may be announced with a different ring sound. For purposes of the present invention, the use of vibration mode commonly included in many cellular telephones may be considered a ring sound. Accordingly, a user 12 may control which petitions 36 are announcing with vibration, either alone or in combination with other ring sounds.

A user 12 may control the voice mail 56 available to petitioners 14 associated with selected ratings 38. For example, a user 12 may grant access to voice mail 56 on a “yes” 64, “no” 66, or “time dependent” 68 basis. In selected embodiments, a user 12 may provide an array of voice mail messages 72 or “greetings” 72. For example, very encouraging messages 72 or greetings 72 may be provided for recitation to petitioners with higher ratings 38 to increase the service provided and the chance that the petitioner 14 will leave a message. Alternatively, less encouraging messages may be provided to correspond to lower ratings 38 to discourage the petitioner 14 from leaving a message unless it is critical.

In certain embodiments, a user 12 may control voice mail priority 74 of playback. For example, a user 12 may specify that voice mail messages be played back in order of decreasing rating 38. Accordingly, voice mail from petitioners 14 of the highest rating 38 may be the first voice mail messages the user 12 encounters during playback.

In some embodiments, a user 12 may control the text messaging 58 available to petitioners 14 associated with selected ratings 38. A user 12 may grant access to text messaging 58 on a “yes” 64, “no” 66, or “time dependent” 68 basis. Additionally, a user 12 may control text messaging priority 76 for playback. Similar to voice mail 56, a user 12 may specify that text messages be displayed in order of decreasing rating 38. Accordingly, text messages from petitioners 14 of the highest rating 38 may be the first messages retrieved from the queue.

If desired, a user 12 may control the call waiting 60 available to petitioners 14 associated with selected ratings 38. Again, a user 12 may grant access to call waiting 60 on a “yes” 64, “no” 66, or “time dependent” 68 basis. Additionally, a user 12 may specify that he or she is not to be advised 78 of new petitions 36 having comparatively lower ratings during calls from petitioners 14 having comparatively higher ratings 38.

In selected embodiments, a user 12 may control the records 62 created by a petition 36. For example, a telephone may save the origination number and time of call. This may be selected to be true even when the petition 36 is not accepted. Accordingly, in some embodiments, it may be desirable to maintain 80 or not maintain 82 a record of a petition 36 based on the rating 38 of the petitioner 14.

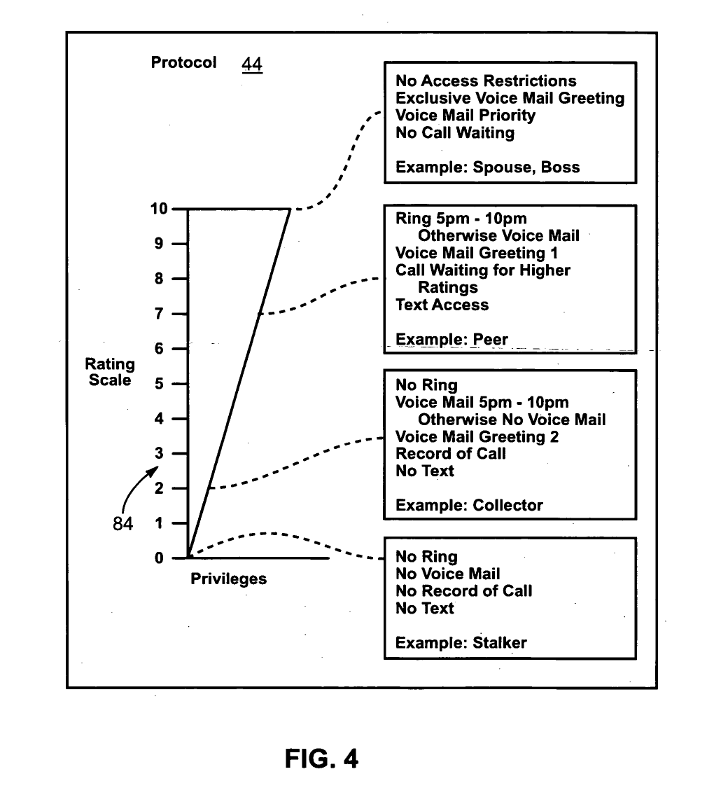

Referring to FIG. 4, a rating 38 may be any value selected from a rating scale 84. A rating scale 84 may be any range providing sufficient resolution for a user 12. For example, in selected embodiments, a one to five ranging scale 84 may be sufficient. In other embodiments, a one to ten rating scale 84 may be adequate. In still other embodiments, a one to zero (i.e. 1, 2, 3, . . . 9, 0) rating scale 84 may be desirable to provide ten different ratings 38 or values that may all be entered using a single key stroke. Other suitable rating scales 84 may include zero to nine, one to three, one to one hundred, etc.

In selected embodiments, a user 12 may select the rating scale 84 he wishes to employ. For example, one user 12 may find a rating scale 84 of one to three to be sufficient. Another user 12 may find a rating scale 84 of one to ten to be more useful. Accordingly, each user 12 may selected a rating scale 84 that best suits his needs.

In general, a protocol 44 may increase the privileges granted the higher the rating 38. Accordingly, on a one to ten rating scale 84, a petition 36 asserted by a petitioner 14 having a rating 38 of two may have significantly fewer privileges than a petition 36 asserted by a petitioner 14 having a rating 38 of ten. For example, a petitioner 14 having a rating 38 of ten may have no access restrictions. That is, the petitioner 14 may have access to ring tones 54, voice mail 56, text messaging 58, etc. at any time of the day or night. Furthermore, the petitioner 14 may receive an exclusive voice mail message when the user 12 is unable to answer. Any message left by the petitioner 14 may be placed at the top of the playback list. Moreover, when speaking with the user 12, the system may be programmed so no call waiting 60 may interrupt the conversation. Examples of petitioners 14 who may have a highest rating 38 (e.g. ten) may be a spouse or a boss.

A petitioner 14 having a rating 38 of seven may have fewer privileges than a petitioner 14 having a rating 38 ten. For example, a petitioner 14 having a rating 38 of seven may have access to ring tones 54 between the hours of 5:00 pm to 10:00 pm. Petitions 36 outside of that time period may be directed to voice mail 56. The voice mail message received may be cordial and encouraging, but less so than the exclusive message received by a petitioner 14 having a very high rating 38 (e.g. ten out of ten). Furthermore, when speaking with the user 12, only calls from petitioners 14 of higher rating 38 may interrupt. If desired, a petitioner 14 having a rating 38 of seven may be granted access to text messaging at any time of day or night. Peers may be examples of petitioners 14 having a “mid-range” rating 38 of seven out of an available ten.

A petitioner 14 having a “low” rating 38 of two out of an available ten may have limited privileges. For example, the petitioner 14 may be granted no access to ring tones 54 or text messaging 58. Voice mail 56 may be available between the hours of 5:00 and 8:00 pm. Otherwise, the incoming call (petition 36) may simply be terminated. The voice mail message may be minimal and not overly encouraging. A record 62 of the call may be kept. Sales persons or collectors may be examples of petitioners 14 who may be given a rating of two.

A petitioner 14 having the lowest possible rating, such as zero of an available nine or ten, may have no privileges. Such a petitioner 14 may be granted no access to ring tones 54, voice mail 56, or text messaging 58. When a petition 36 from such a petitioner 14 is received, the call may terminated. No record 62 of the call may be maintained. A stalker or harassing caller may be an example of a petitioner 14 who may be given a lowest possible rating.

Selected embodiments in accordance with the present invention may allow a user to create and apply an override to a protocol 44. The override may be any filtering scheme that is different from the otherwise applicable protocol 44. In general, an override may be defined as a protocol 44 individually selected to be applicable for a specific or particular situation.

For example, a user 12 may desire in certain circumstances not receive any petitions 36. Accordingly, the user 12 may turn off his telephone. However, in certain circumstances, a user 12 may not want to be called by anyone except those of highest priority. In such situations, the user 12 may enter an override command into the user interface 22 indicating that only petitions 36 from petitioners 14 having rating at or above a maximum, e.g. such as nine out of an available nine or ten, are to be granted any access that interrupt the user 12. With the override in place, calls that, according to the otherwise applicable protocol 44, would ring through, may be directed to voice mail. Additionally, any interruption, beep, or the like, that may advise a user 12 that a voice mail message was received may be precluded.

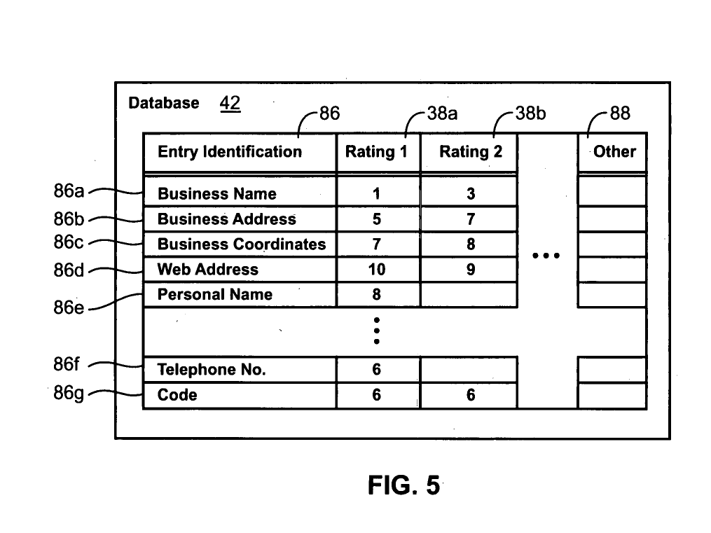

Referring to FIG. 5, a database 42 in accordance with the present invention may be arranged in any suitable manner. In general, a database 42 may be arranged to store a name 86 or entity identification 86 coupled to the one or more ratings 38a, 38b. However, if desired or convenient, other information 88 may also be coupled to a name 86.

A name 86 may be anything that uniquely indicates a particular petitioner 14 and is susceptible to being stored in a database 42. For example, a name 86 may be a business name 86a. In other embodiments, a name 86 may be a business address 86b. In still other embodiments, a name 86 may be the geographic coordinates 86c (e.g. longitude and latitude) of a business establishment. Other suitable names 86 may include web addresses 86d, e-mail addresses, personal names 86e, telephone numbers 86f, codes 86h (e.g. alphabetic, numeric, alphanumeric), and the like.

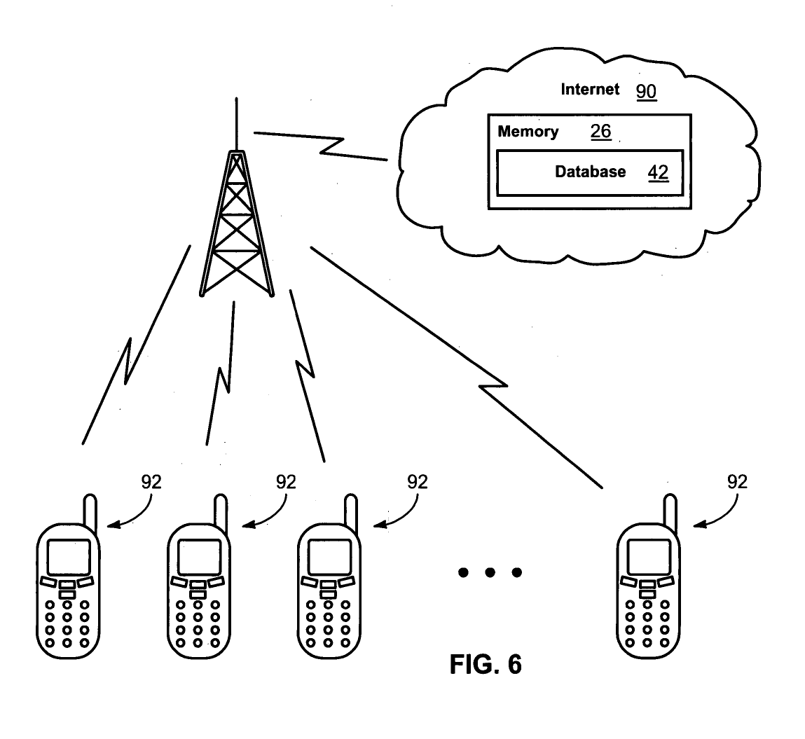

Referring to FIG. 6, in selected embodiments, a database 42 may be stored in memory 26 on the Internet 90. In such embodiments, the database 42 and the ratings 38 contained therein may be made accessible to a large group of users 12. For example, in some embodiments, executables may be downloaded from the Internet 90 onto the cellular telephones 92 of one or more users 12. In combination with the user interface 22, processor 24, and memory 26 of the cellular telephone 92, the executables may form a buffer 16 in accordance with the present invention. Ratings 38 received from a user 12 through a cellular telephone 92 may be stored within the database 42 hosted on the Internet 90. Accordingly, users 12 may submit ratings as well as benefit from the ratings 38 provided by others 12.

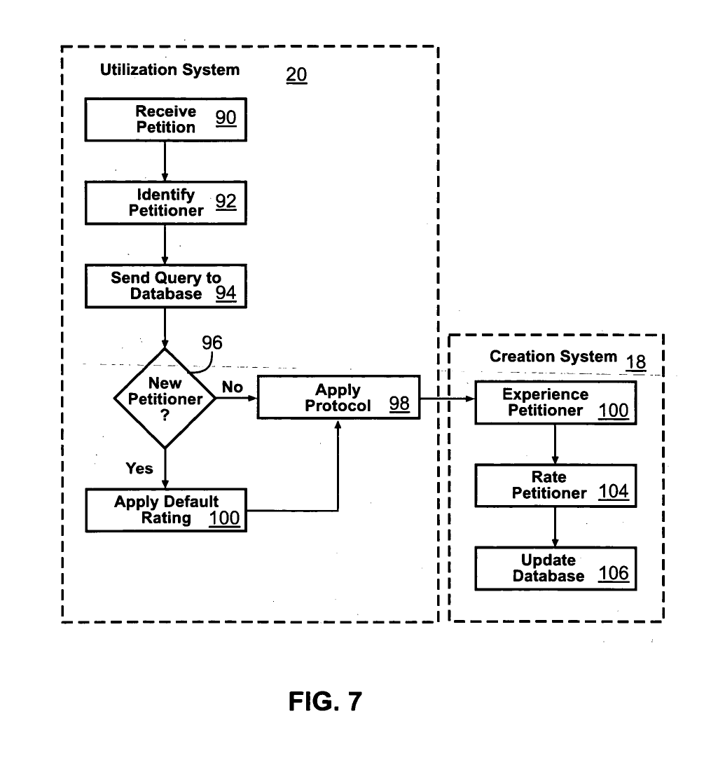

Referring to FIG. 7, in operation, a utilization system 20 may receive 90 a petition 36. By examining the petition 36, the utilization system 20 may identify 92 the petitioner 14. With the identity of the petitioner 14 known, a query 46 may be sent 94 to the database 42 to retrieve the rating 38 associated with the petitioner 14. With the information retrieved from the database 42, a determination 96 may be made. If the petitioner 14 has previously been rated and that rating 38 is stored in the database 42, the protocol 44 may be applied 98. Otherwise, a default rating 38 may be applied 100 before the application 98 of the protocol 44.

A default rating 38 may be selected by a user 12. Any value selected from a rating scale 84 may be an appropriate default rating 38. For example, in one embodiment, on a rating scale 84 of one to ten, five may be a useful default rating 38. With a rating 38 of five, a previously unknown petitioner 14 will not be disregarded, but will not be given top priority either.

Once the protocol 44 has been applied 98, the processed petition 50 may be passed to a user 12. At this stage, a creation system 18 may take over. In the creation system 18, the user may “experience” 102 the petitioner 14. Experiencing a petitioner 14 may involve taking a call from the petitioner 14, reading an e-mail, facsimile, letter, etc. sent by the petitioner 14, patronizing the business of the petitioner 14, or the like. Having experienced 102 the petitioner 14, the user 12 is in a position to rate 104 the petitioner 14. This new rating 38 may then be used to update 106 the database 42.

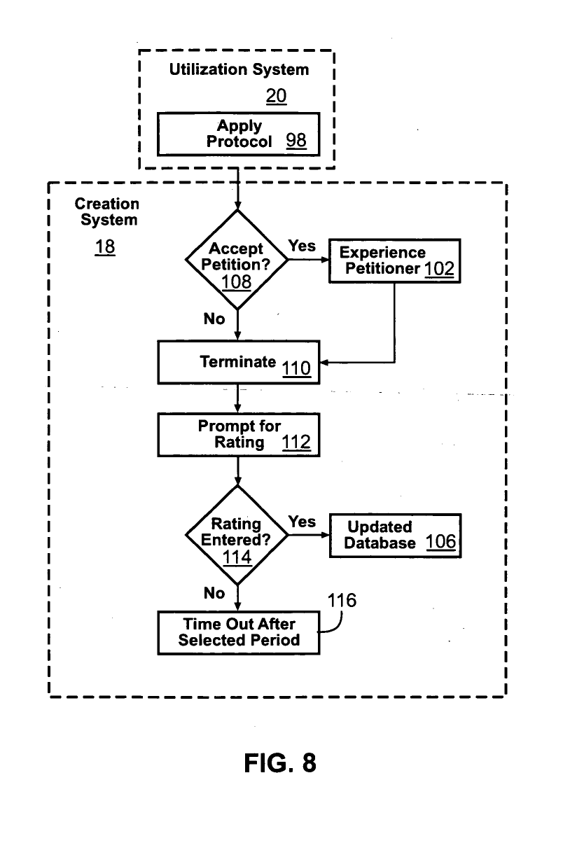

Referring to FIG. 8, various methods may be used to present a user 12 with the opportunity to rate 104 a petitioner 14. For example, when a processed petition 50 is passed to a user 12, the user 12 may decide 108 whether to accept it. If the user 12 chooses to accept the processed petition 50, the user 12 may experience 102 the petitioner 14 as discussed hereinabove. Alternatively, the user 12 may decide to terminate 110 the processed petition 50. Either way, eventually the processed petition 50 is terminated 110.

Upon termination 110, the creation system 18 may prompt 112 the user 12 for a rating 38 corresponding to the petitioner 14. If a user 12 enters 114 a rating 38, the database 42 may be updated 106 accordingly. If the user 12 does not enter 114 a rating 38, the prompt 112 may time out 116 and disappear after a selected period of time. For example, the prompt 104 may time out 116 and disappear five seconds after termination 110.

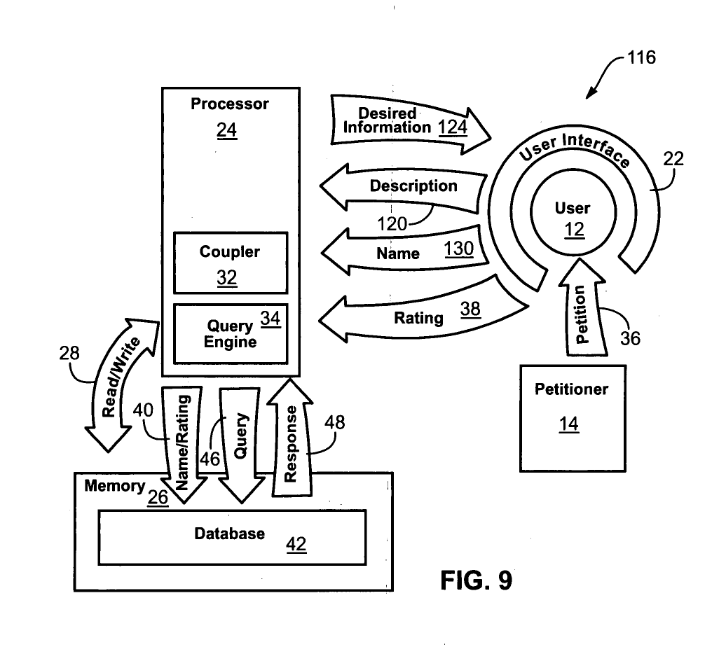

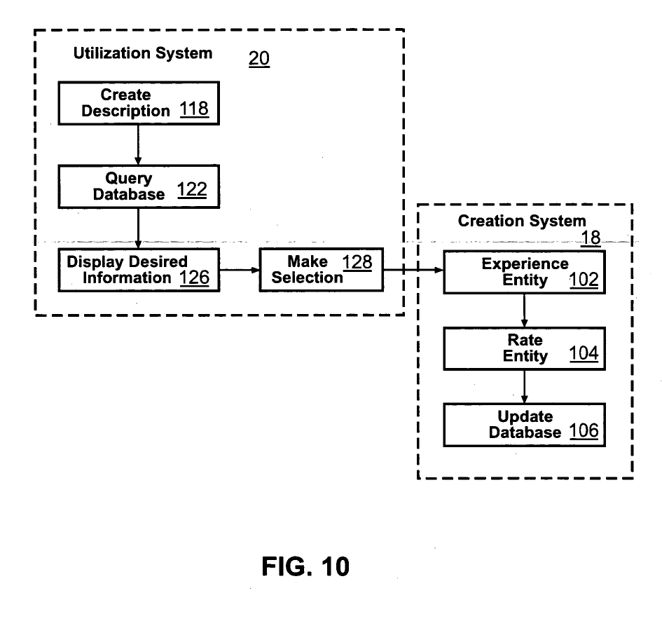

Referring to FIGS. 9 and 10, certain types of petitions 36 do not readily lend themselves to examination by an identifier 30 to determine the name of the petitioner 14. For example, it may be difficult for hardware, software, or some combination of hardware and software to determine the name of a petitioner 14 sending a petition 36 to a user in the form of a visual advertisement (e.g. billboard, magazine advertisement, television commercial, etc.). It may be even more difficult to process such petitions 36 before they reach a user 12. However, in selected embodiments of the present invention designed to handle such petitions 36, an identifier 30 may be omitted or left dormant while the functions of the identifier 30 are performed by the user 12. In such embodiments, the processor 24 and memory 26 may function more as a resource for the user 12, rather than a filter to automatically process incoming petitions 36.

For example, in response to a petition 36, a user 12 may be motivated to inquire regarding what ratings 38 a particular petitioner 14 or group of petitioners 14 has received from others. Accordingly, a user may create 118 and send a description 120 of desired rating information to a processor 24. A query engine 34 within the processor 24 may form an appropriate query 40, which may be submitted 122 to the memory device 26. When the processor 24 receives a response 48 to the query 40, the desired information 124 contained therein may be displayed 126 for the user 12.

From the information 124 displayed 126, a user 12 may make a decision 128 or selection 128 with respect to the petition 36. For example, if the petition 36 is an advertisement, a user 12 may decide 128 to purchase products or services because the petitioner 14 has received high ratings 38. Alternatively, a user 12 may decide 128 avoid a petitioner 14 that has received low ratings 38.

In selected embodiments, a petition 36 may be submitted to a user 12 some time before the user 12 decides to look for rating information. This time may be significant (e.g. days, months, years, etc.). A petition 36 may also find a user 12 in a very indirect manner. For example, a friend of the user 12 may say “I saw a sign for Joe's Grill about a block back. Do you want to eat there?” The sign indicating “Joe's Grill” may be considered a petition 36 inviting the user 12 to purchase food. Accordingly, if a user 12 acting on his friend's question, seeks information about the ratings 38 of Joe's Grill, the user 12 is employing systems and methods in accordance with the present invention.

In the absence or inactivity of an identifier 30, during the rating process of the creation system 18, a coupler 32 may receive the name 130 of a petitioner 14 being rated from the user 12. Accordingly, when the processor 24 receives a rating 38 from the user interface 22, the coupler 32 may bind the rating 38 to the appropriate name 130 and pass the set 40 to the memory device 26 for storage.

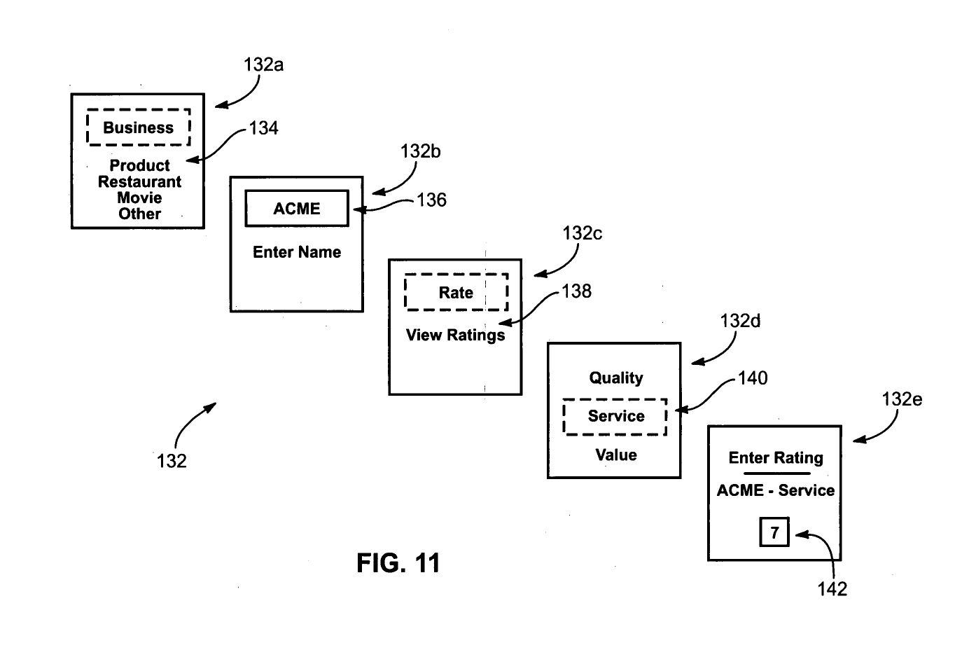

Referring to FIG. 11, a user interface 22 may lead a user 12 through the creation and utilization systems 18, 20 in any suitable manner. In selected embodiments, a user interface 22 may present a series of screens 132 displaying various menus, input requests, and the like. For example, one screen 132a may present a menu of general categories 134 of petitioners 14. Such a menu 134 may contain categories such as businesses, products, restaurants, movies, other, and the like.

Another screen 132b may present an input field 136 where a user 12 may enter the name 130 of a petitioner 14. In selected embodiments, this input field 136 may also accept search terms for searching the database 42. Another screen 132c may present a menu of activities 138. For example, a user 12 may select “rate” to enter ratings 38 or “view ratings” to view the ratings 38 already entered into the database 42.

Another screen 132d may present a menu of subcategories 140. In one embodiment, a menu of subcategories 140 may permit a user 12 to select ratings 38 in particular areas. For example, a menu of subcategories 140 may permit a user 12 to choose to enter ratings or view ratings related to quality, service, value, and the like. Another screen 132e may present an input field 142 where a user 12 may enter a rating 38. The order of the various screens 132 may vary in different embodiments.

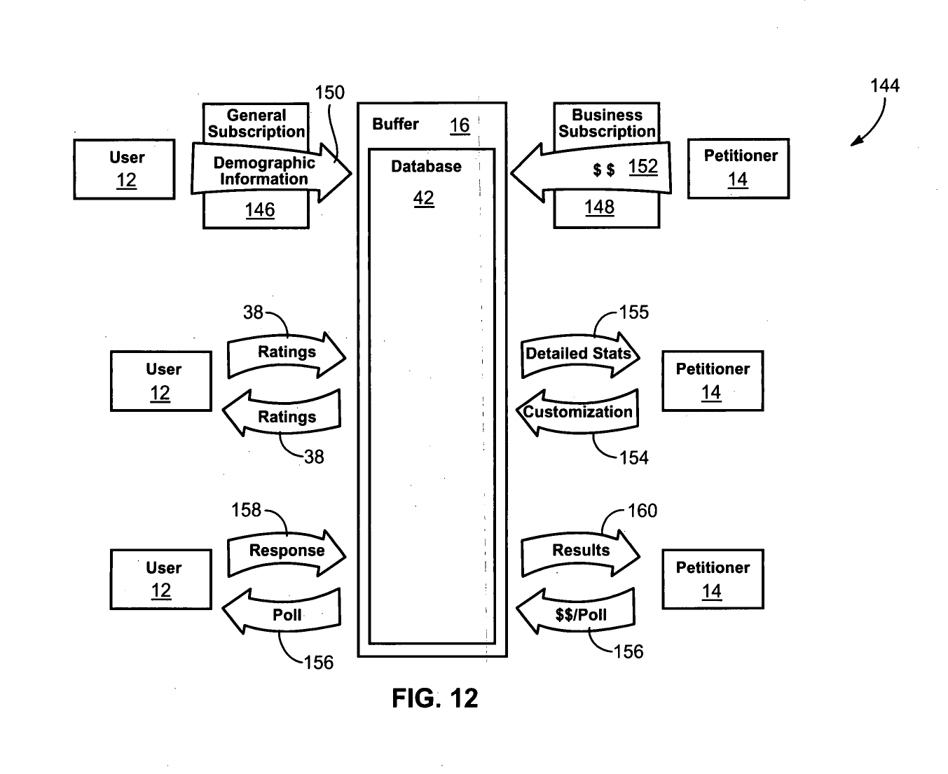

Referring to FIG. 12, in selected embodiments, a subscription system 144 may control the access of users 12 and petitioners 14 to a buffer 16 in accordance with the present invention. For example, users 12 may subscribe to a buffer 16 through a general subscription 146. Petitioners 14 may subscribe to the buffer 16 through a business subscription 148. The requirements of a general subscription 146 and a business subscription 148 may differ in accordance with the primary interests of the user 12 and petitioner 14, respectively.

In certain embodiments, a user 12 may be required to submit certain demographic information 150 in order to obtain a general subscription 146. The demographic information 150 may be tied to all the ratings 38 entered by the user 12. Accordingly, the demographic information 150 may provide useful insights into the preferences of users 12 within specific categories of interest. Such insights may be valuable to certain petitioners 14. Accordingly, a petitioner 14 may be required to pay a fee 152 in order to obtain a business subscription 148.

Once subscribed, a user 12 may submit ratings 38 and view ratings 38 entered by others. A petitioner 14, on the other hand, may customize 154 the rating subcategories corresponding thereto. For example, a restaurant petitioner 14 may seek feedback from users 12 with respect to taste, price, etc. A petitioner 14 that is a software programer may seek feedback with respect to ease of use, fixes or patches, etc. Accordingly, a petitioner 14, to a selected degree, may control the areas or subcategories in which the petitioner 14 is to be rated. As a result, a petitioner 14 may receive detailed statistics 155 of high utility from the mutually accessible buffer 16.

In selected embodiments, for an additional fee, a petitioner 14 may submit a poll 156 to users 12 having one or more selected characteristics (e.g. age, gender, location, etc.). Users 12 may accept a poll 156 and return a response 158. Results 160 from the poll 156 may be returned to the petitioner 14 and communicate the desired information.

Suitable motivational arrangements may be applied to encourage users 12 to accept and answer polls 156. For example, a user 12 may receive a portion of the additional fee paid by the petitioner 14 when submitting the poll 156. Alternatively, a user 12 may receive a discount on a service operating in conjunction with the buffer 16. For example, in embodiments utilizing cellular telephones 92, a user 12 may receive a discount on the service fee for the cellular telephone.

The following examples will illustrate the invention in further detail. It will be readily understood that the Examples herein are merely exemplary of the various embodiments of the present invention. Thus, the following more detailed description contained in the Examples is not intended to limit the scope of the invention, as claimed, but is merely representative of the possible embodiments and applications of the present invention.

### EXAMPLE I

In selected embodiments, buffers in accordance with the present invention may be configured as Personal Rating Systems (PRS). In some embodiments, PRS may be defined as software on the cellular telephone of a user that allows the user to rate each caller and to specify the privileges associated with each rating. PRS may serve users of all kinds. There need not be required infrastructure alterations or modifications. All that is needed is a cellular telephone with a compatible operating system. PRS applications may be downloaded onto the cellular telephone. Alternatively, PRS applications may come already installed on a new cellular telephone. PRS may be used to generate revenue through a set-up fee, download fee, service fee, or the like.

Users want the power to treat different callers in different ways. However, manually specifying the privileges for each caller is likely too inconvenient for most users. PRS simplifies the task down to a single keystroke. At the end of each call (incoming or outgoing), a user may be given the option to rate the caller on a rating scale (e.g. 1, 2, 3, . . . 9, 0). The rating that the user chooses will determine how calls from that caller will be treated in the future. That is, the user is assigning a user-defined bundle of privileges to each individual with a simple keystroke or short sequence of keys.

The caller rating process may begin when a call is received. PRS may isolate the telephone number from which the call originates and search for the number in one of two databases. The first database may be a personal phonebook containing a manually entered listing provided by a user. The personal phonebook may include user-defined names. The second database may be a collected listing containing the telephone numbers of callers who are not listed in the personal phonebook. The collected listing may be formed automatically from the caller identification. Telephone numbers may be held in the collected listing for a certain period of time. Alternatively, telephone numbers may be held in the collected listing until the listing is full. Once the collected listing is full, the oldest number may be deleted to make room for a new addition.

If a caller is found in one of the databases, the PRS may retrieve the corresponding rating and handle the call according to the predefined protocol for callers of that rating. If a caller is not found in either database, the user may have the option of refusing the call, manually entering a rating, or sending the call to voice mail. Alternatively, the call may be handled according to the user's predefined protocol for new calls. The number may then be added to the collected listing.

After the user finishes a call, PRS may give the user the option to rate the caller. If the user chooses to rate the caller, the rating is stored. Because a user is able to rate each call from a particular caller, PRS may calculate the average rating based on some equation such as a time-weighted valuation process. That is, more recent ratings may be given greater weight before they are averaged with older ratings. PRS may also provide the option for an indefinite rating for each caller, which eliminates the need for ongoing call rating.

With zero being the highest rating, a caller having a rating of zero would have the highest level of access to the user. All calls coming from that caller would ring through (or vibrate through) depending on the setting provided by the user. If a voice mail is to be left, the caller may be greeted with an exclusive voice mail message. Conversely, a caller having a rating of six may ring through during certain hours of the day, and go straight to voice mail during other hours. A caller with the lowest rating, may never ring through nor be permitted to leave a voice mail or send a text message. Moreover, the user may never know that a call was even attempted.

If a caller knows he may be rated poorly, he will be more inclined to behave in positive ways. The caller may choose not to talk as long. The caller may choose to be more courteous. He may try harder to call at appropriate times. Consequently, the general populace should begin to act with more tact and courtesy on the telephone.

Some of the user-defined privileges (e.g. voice mail access, greetings, etc) require support from the user's service provider. Therefore, rating data may be transmitted to the service provider. As a result, PRS may also be considered a service for which providers may charge. Data transfer between a cellular telephone and a service provider may occur in real-time. Alternatively, data transfer may occur when the cellular telephone is idle or being used for another purpose.

Each user may be able to access the preferences of privileges of his PRS from his cellular phone or through the Internet. Internet access may require the user to log in to view his account. Once the user is securely logged in, he may be able to determine and adjust all of his PRS-related preferences.

There are many times that a petitioner or user would rather leave a voice mail than talk directly to someone. PRS may allow a user or petitioner to be voluntarily sent to voice mail instead of ringing through.

### EXAMPLE II

PRS Plus may be an upgrade to the PRS described in Example I that gives the user the ability to distinguish between personal and business calls. Users treat business calls and personal calls in very different ways. Privileges assigned to personal calls may differ from the privileges assigned for business calls. For example, a user may give ring-through privileges to those with a rating of seven on the personal side between the hours of 5:00 p.m. and 10:00 pm. However, the user may give ring-through privileges to those with a seven on the business side during normal business hours. In another example, a spouse may be receive a high rating on the personal side, while a favorite client may receive a high rating on the business side. Consequently, the personal rating and the business rating may be treated to different voice mail messages, etc.

In selected embodiments, business ratings may be combined with the business ratings given by other users. This combined business rating may be shared, allowing PRS Plus users to identify undesirable business callers, and to treat them accordingly, without ever experiencing and rating the business personally. For example, suppose a user receives a telephone call from a sales representative, and the representative is rude. Accordingly, the user rates the business with a two. Consequently, any call coming from this number will be treated accordingly on that user's telephone. In addition, this rating is factored into the caller's general business rating. After a minimum number of ratings have been collected, the average business rating may assist in determining how a new call from that business is treated.

### EXAMPLE III

In selected embodiments, buffers in accordance with the present invention may be configured as a Rating Network. A Rating Network may comprise global sytems linking users to any one of a series of databases. Rating Networks may faciliate gathering, storing, and accessing ratings and information about the users submitting the ratings. In general, Rating Networks may effectively give users the power to rate anything at anytime.

Users want to rate more than just callers. By becoming subsribers, users may gain access to a Rating Network giving them such an option. Users of a Rating Network, or subscribers to service-providers providing access to the Rating Network, may rate businesses, products, restaurants, political candidates, movies, city maintenance, education systems, or the like. They may access a Rating Network on their cellular telephone, type in the subject they want to rate, rate the subject, and add optional comments as if writing a text message.

If every cellular telephone were equipped with the necessary application software, and if every cellular telephone user was a subscriber, there would be hundreds of millions of ratings collected each day over a Rating Network. Fortunately, because of the nature of cellular telephones, every rating, vote, or comment may be linked to an individual and a specific location. Every rating may be filtered and cataloged according to age, gender, and geographic location. Also, because each rating is tied to one specific cellular telephone, and because of the anticipated volume of ratings, abuse and manipulation of the Rating Network may be monitored and eliminated.

All ratings and information about those submitting the ratings may be gathered over a Rating Network and collected in one of two databases, namely, a general repository and a business registry. In the general repository, all ratings of unregistered subjects may be collected. Any user may type in the name of the subject on his cellular telephone, rate the subject, and give optional comments. If the subject is not listed in the general repository, the Rating Network may respond with a list of subjects that are the most similar to the entered subject. This may happen in real-time or by delayed response, depending on the data transfer mode.

Users may also be given the option to search the general repository to find a rating, or to find a subject to rate. Because of the expected high volume of superfluous data, misspelled entries, and bogus content, when a user performs a search, only the most popular subjects or entities may be listed. Various factors including geography, age and preference of the user may be used to make a determination of what the most popular subjects or entities may be.

In the business registry, all ratings of subjects that are registered with, or subscribers to, a Rating Network may be collected. The business registry may be a highly-regulated database that is easy to navigate. The business registry may also support more specific ratings. For example, a user may rate product quality, service, value, etc. Rating registered businesses on a Rating Network may be facilitated by quick codes. Quick codes are alphanumeric codes assigned to each registered entity. Quick codes make rating easier by eliminating the need to spell out each business, or search the database. Eventually, quick codes may be posted with as much frequency as web addresses.

When a user subscribes to a Rating Network, he may be asked to include his date of birth, gender, ethnicity, religious affiliation, political affiliation, and the like. This information may then be tied to his specific cellular telephone number. This information may be very useful by allowing the ratings to be filtered according to demographic parameters.

As an incentive to increase the amount of demographic information a user provides, a user, when viewing ratings, may only see ratings broken down in the areas of demographic information that the user provided. For example, if a user in registering only submits his age and gender, then when the user trys to view ratings for a new film, he may only see the overall rating and the rating given the film by those of his gender and in his age group. If the user also provided his ethnicity, he may then view the rating given the film by those of his gender, age, and ethnicity.

Perhaps as important as knowing the identity of a rater, is knowing where that rater is when he rates. Every telephone number has an associated area code that defines the geographic region of the user. While the area code may be very helpful in determining location, other methods may provide more detail. For example, many new cellular telephones include locators (e.g. Global Positioning Systems). Such locators may identify a cellular telephone's position to within a few up to two hundred feet. A Rating Network may use locator data to identify where a user is when he rates. For example, in any given city there may be a number of restaurants owned by a particular chain. A user may be treated poorly, and consequently rate the chain poorly. Locator information may help the business know which restaurant had the bad service.

A Rating Network may be activated when a user presses an exclusive button on his telephone. Alternatively, a user may select the Rating Network from a menu on his telephone. When the Rating Network is activated, the user may have the option to link to the primary user interface of the database or databases. At this point, the user may navigate through menus or search for the name of the business (or other subject) he would like to rate or for which he would like to view the rating. All subjects may be searched by name, type, geographic location, or any combination of those factors. Users may also type in a quick code to locate a subject.

Depending on access speeds, and other technical requirements, users may have the option to rate a subject without linking to a Rating Network. The rating information may be transmitted to a database at a later time. If more information is needed from the user, the user may be prompted the next time he activates his telephone.

The process of uploading rating information from the user's telephone to a Rating Network may be performed in a number of different ways. These options may include, but are not limited to direct real-time transfer, delayed manual transfer, delayed automatic transfer, or automatic transfer during normal telephone operation. A direct real-time transfer may require a direct connection to the Rating Network or a sub-network. The user may search for an entity to rate, and enter his rating and other information directly. In this mode, a user may also enter a quick code, giving him the option to view the subject's rating information, current promotions, and nearby competitors with their ratings.

A delayed transfer may be useful when a user is outside of his service area or is otherwise unable to connect with a Rating Network. Using quick codes or another identification, the user may still rate the subject on his telephone. The telephone may then upload the data to the Rating Network when sufficient reception is available.

Another way to add convenience to the user and reduce the traffic on communication systems is to transmit the rating data and other information during a telephone call. In such cases, the rating data “piggy-backs” on the data channel that has been selected for the call.

Through a Rating Network, users may select the businesses they want to patronize based on ratings submitted by the populace. If a user needs help deciding which restaurant to patronize in a particular (e.g. unfamiliar) city, he may access the Rating Network. The Rating Network may allow him to browse nearby restaurants based on their rating. The Rating Network may then provide the address and telephone number of the restaurant he chooses as well as any promotions that restaurant may be running.

A Rating Network gives businesses the power to rate their customers. Whenever a representative of a business is talking on the telephone with a customer or client, he may be given the opportunity to rate that customer. Ratings from across the business may be compiled in an internal database and used to determine how each member of the business interacts with that customer. A customer may earn a high rating by being a good customer who is pleasant on the telephone. A customer may earn a low rating by being rude and demanding. Through a Rating Network, businesses have the power to provide superior service to their best customers, and refuse or delay service to problematic customers in favor of better ones.

Users may be able to access a Rating Network through an official site hosted on the Internet. Users logged into the official site may access a Rating Network and rate or view ratings. The site may include a search engine performing searches of the business registry, general repository, some other database, or any combination thereof. Businesses who register on the Rating Network may have their website links posted on the search results. Users may access the site, type in their search criteria, and have all of the relevant businesses or entities prioritized according to their geographic location, general rating, number of ratings received, etc. The site search engine may not compete directly with current search engines as it does not rate or search all websites on the web.

On their websites, registered business may post their rating as well as provide links to a Rating Network. A registered business may have the ability to choose what data is posted on its website. For example, if the business rates high in customer service but low in product quality, it may choose to only show the customer service rating on its site.

A Rating Network may provide signifiant benifits to both users (e.g. customers, consumers) and peitioners (e.g. businesses). For example, consumers may search the Rating Network to find a particular business to fit a particular need. Both “mom and pop” shops as well as national chains may be rated. Accordingly, someone from “out of town” may find the highest-rated local restaurant.

Due to the volume of ratings, and the one-phone-one-vote reality, it may be virtually impossible to manipulate the ratings. The large numbers may extinguish any attempt at manipulation. Also, because each rating may be traced back to a particular geographic area, outliers in the ratings may be identified.

A Rating Network may give businesses unprecedented access to the feedback of their customers. They may enjoy immediate updates identifying the problems in their organization. Businesses will inevitably improve their customer relations, as a perpetually negative rating may destroy a business.

In certain embodiments, a business may rate its customers on the Rating Network. Once customers are rated, the rating and customer identification may uploaded to a database. Businesses may access the database only if they subscribe to a Rating Network. They may also only access names and ratings of their own customers. If a business' databases are connected to the Rating Network, the business may match up telephone numbers and create a separate visible database to check the average ratings given by all departments within the business, or by other businesses.

Businesses may choose how to deal with customer based on ratings. For example, customers with high ratings may be offered special promotions, discounts, etc. Customers with low ratings may be handled more sternly or cautiously. Businesses may have a better understanding of customers. If customers are “difficult” with several businesses, they may receive low ratings and be denied service. Accordingly, negotiation skills and courtesy may become the best tools to getting the deal.

### EXAMPLE IV

In selected embodiments, a Rating Network may be used for credit card protection and purchase ratings. Every time a consumer makes an electronic purchase, the device accepting the card information may send a notification to the cardholder's cellular telephone. Because this notification is immediate, the card holder may accept or reject the purchase. The consumer could then be protected against any fraudulent use of his credit card information.

When the consumer is notified of the purchase, he may rate the purchase on the Rating Network. This information may be valuable to businesses desiring to track customer satisfaction and customer loyalty. This may also help the business distinguish between general feedback and customer feedback.

Also, because these notifications are being transferred across a Rating Network, the Network may store all consumer transaction records, thereby recording trends in consumer spending, and other valuable data. Consequently, consumers may track, or be notified of, any changes in the ratings of businesses they frequent.

### EXAMPLE V

In selected embodiments, a Rating Network may include Business Services where, for a fee, subscribing businesses may access detailed information about their ratings. While all subscribers may have access to general ratings, only Business Services subscribers may access the specific information behind the rating. For example, they may access specific information on the person that rated them. Businesses may know the anonymous age, gender, area code, locale, etc. as well as the personal ratings of those that rated them. Businesses may then filter the information desired.

For example, a business may receive a low, prank rating from a user. The business may learn that the user who rated it poorly had a low personal rating. Due to the low rating of that user, the business may automatically filter that input, or otherwise conclude that the user's opinion is more indicative of personality than of any problem in the business.

All Business Services subscribers may be listed in the business registry, described hereinabove. Because of the unregulated nature of the general repository, it may be less convienient to navigate and may not provide the level of rating detail that most businesses desire. The business registry, due to its regulated nature, may be easy to navigate, thereby permitting specific business-defined rating subcategories or criteria (e.g. service, cleanliness, delivery, advertising, etc.).

Business Services subscribers may also have the option to choose additional services. These services may include promotions that show up on the consumer's telephone when they select the client's business, addresses and maps to their business, or any other value-added service to the client.

Subscription fees for Business Services may vary depending on the size and market of each business. A small company doing business in only one city may pay a relatively small amount. A national chain, on the other hand, may pay more for the considerable amount of information that would be gathered on its behalf.

All businesses subscribed to Business Services may be assigned a quick code unique to the business. These quick codes may facilitate consumer ratings because consumers won't have to spell out the business name or product, or search the business registry to find a particular business. In selected emboidments, quick codes may be posted on business cards, signage, advertisements, and the like.

Quick codes may be assigned in any number of ways. For example, national firms may utilize a different code system than local firms. A local merchant in one city may have the same alpha-numeric code as another in another city. However, both merchants may be classified as “local” and exist in different areas. Accordingly, the rating network may utilize a locator within the rating device (e.g. cellular telephone) to distinguish between rating directed to one and rating directed toward the other.

Businesses in similar industries may be assigned similar quick codes. For example, all restaurants may begin with the same sequence. Consequently, the user's telephone may know what rating subcategories (e.g. service, quality of food, presentation, ambiance, etc.) to present to the user without having to access the Rating Network. This may enable customers to rate businesses even if the rating device has no reception in a given area. The data transfer may ocur when adequate reception returns.

In addition to faciliating rating and viewing ratings, quick codes may also be used to view special deals or promotions from the corresponding business. The quick code may also faciliate presentation to the consumer a list of competing establishments and their ratings, links to the businesses' website, or any other useful and transmittable information.

### EXAMPLE VI

In certain embodiments, a Rating Network may include Research Services where, for a fee, subscribing businesses may submit polls and market research questions to customers. Pricing for Research Services may depend on the number of consumers the business wants to reach. A poll reaching two hundred teenagers may cost significantlly less than a poll reaching two million teenagers. Consumers who subscribe to certain services may have the choice to reduce their monthly subscription if they agree to answer a minimum number of polls each month. Those users who chose not to take the deduction may still have the option to request polls at their leisure.

The database of a Rating Network may contain valuable demographic information volunteered by each subscriber. This information may be used to filter population samples. Accordingly, businesses or other entities seeking to poll consumers may specify the type of individual they want polled. For example, a business may direct a poll to males between the ages of 18 and 21 living in a particular geographical region. Research Services may provide market research that is more accurate, immediate, comprehensive, and cost-effective than is currently available.

There may be many polls that are not of interest to some subscribers. Consequently, in selected embodiments, a subscriber may pass on any poll question. If a subscriber passes on a poll question, Research Services may note the topic of that question stop sending polls with that subject matter. In this way, Research Services may customize the polls received by a subscriber.

### EXAMPLE VII

A Rating Network may be divided into any one of a number of subcategories. These categories may be selected to help a user (e.g. consumer) understand how others like him, or whose opinion he values, experienced a particular petitioner (e.g. business, product, movie, etc.).

In selected embodiments, Kingdoms, Cliques, or Friends may be defined as social networks of varying scale defined by the user's highest rated callers. Such groups may provide a filter, or firewall that only presents the consumer with the highest rated products and services within these personal social networks. These groups may be protected from low-quality companies, services, products, etc. In some embodiments, Kingdoms may represent large consumer groups that may be targeted by marketing campaigns.

In certain embodiments, users may identify individuals who may be characterized as Advisors. An Advisor may be an individual whose opinions the user trusts on specific subjects. Users may look to their hand-picked Advisors to see how the Advisors rated selected subjects and to receive suggestions on restaurants, movies, places to shop, products to buy, and the like. As more users select Advisors, individuals may arise who advise many consumers on a specific subject. These Advisors may become the focus of marketing efforts within that subject area. Advisors may become the a significant link between consumers and businesses.

In some embodiments, trend analysis, psychographic and demographic profiling, and informatics may be used in combination with rating histories from a Rating Network to predict and recommend, with a high degree of accuracy, what a particular user will like. In effect, such analysis may produce a virtual, customized Advisor.

If desired, a Rating Network may be used to filter the materials displayed in Internet searching and browsing. Products, services, web pages, e-mails, solicitations, etc. from petitioners with high ratings may be given priority when the user accesses the Internet. The user may be given the option to block out everything else.

In selected embodiments, a Rating Network may provide a periodic (e.g. weekly) consumer newsletter. In some embodiments the newsletter may be delivered through e-mail. If desired, a newsletter may contain links to more complete surveys from businesses the user rated recently, links to websites of businesses the user rated recently, informative articles, press releases from companies the user rated recently, business news, comparisons of the user's recent ratings to the ratings of his Kingdom, Advisors, etc., promotions from businesses the user recently rated highly, updates on the number of ratings or raters in a certain subject area, top rated products and services in the selected subject areas, top rated movies, Advisor picks, Advisor success stories, and the like.

The present invention may be embodied in other specific forms without departing from its features, functions, or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A method comprising:
providing a database;
storing, in the database, a name corresponding to an entity coupled with a value selected from a rating scale to characterize the entity;
providing a processor;
receiving, by the processor, a petition from the entity; and
providing an executable operable on the processor to extract the name from the petition, retrieve from the database the value coupled to the name, and grant privileges to the entity according to the value.

2. The method of claim 1, wherein the petition comprises an incoming telephone call.

3. The method of claim 2, wherein the name comprises a telephone number from which the incoming telephone call originates.

4. The method of claim 3, wherein the executable is operable on the processor to grant privileges selected from the group consisting of ringing access, voice mail access, text messaging access, and call waiting access.

5. The method of claim 4, wherein the value comprises an integer selected from a rating scale.

6. The method of claim 5, wherein the rating scale is within a range included between zero and ten.

7. The method of claim 5, wherein the rating scale is within a range included between zero and eleven.

8. The method of claim 5, wherein the rating scale is within a range included between zero and one hundred.

9. The method of claim 5, wherein providing an executable further comprises providing an executable operable on the processor to grant greater privileges with increases in the value.

10. The method of claim 9, wherein providing an executable further comprises providing an executable operable on the processor to grant no ringing access, voice mail access, text messaging access, and call waiting access when the value is equal to one.

11. The method of claim 10, further comprising storing the database in memory physically located within a cellular telephone.

12. A method comprising:
providing a database storing a plurality of names and a plurality of ratings, each rating of the plurality of ratings representing a value selected from a rating scale, each name of the plurality of names being coupled to at least one rating of the plurality of ratings;
providing a processor;
receiving, by the processor, a petition; and
providing an executable operable on the processor to extract from the petition a name corresponding to the source of the petition, retrieve from the database the at least one rating corresponding to the name, and directing the petition according to the at least one rating.

13. A method comprising:
providing a database storing a plurality of names and a plurality of ratings, each rating of the plurality of ratings representing a value selected from a rating scale, each name of the plurality of names being coupled to at least one rating of the plurality of ratings;
receiving a query requesting the at least one rating corresponding to a subset of the plurality of names;
providing a processor; and
providing an executable operable on the processor to retrieve from the database the subset of the plurality of names and corresponding at least one rating.

14. The method of claim 13, further comprising providing a user interface providing communication between a user and the processor.

15. The method of claim 14, wherein receiving a query further comprises receiving a query from a user through the user interface.

16. The method of claim 15, further comprising presenting, to a user, the subset of the plurality of names and corresponding at least one rating through the user interface.

17. The method of claim 16, further comprising housing the processor within a cellular telephone.

18. The method of claim 17, further comprising establishing a site on the Internet to host the database.

19. The method of claim 18, wherein a portion names of the plurality of names are selected from the group consisting of business names, business addresses, geographic coordinates of business establishments, numeric codes, and alphanumeric codes.

20. The method of claim 19, wherein the subset of the plurality of names comprises a listing of all businesses of a selected type located within a selected geographical area.

21. A method comprising:
providing a database;
providing a processor in communication with the database;
receiving, by the processor, a name corresponding to an entity;
receiving, by the processor, a value selected from a rating scale to characterize the entity;
storing, in the database, the name coupled to the value.

22. The method of claim 21, further comprising housing the processor within a cellular telephone.

23. The method of claim 22, further comprising establishing a site on the Internet to host the database.

24. The method of claim 23, wherein the name is selected from the group consisting of a business name, a geographical location corresponding to a business establishment, a code corresponding to the entity, and an identifier corresponding to a product.

25. A method comprising:
receiving a request for access from a petitioner;
identifying the petitioner;
querying a database to retrieve a first rating corresponding to the petitioner; and
discriminating the petition in accordance with the first rating.

26. The method of claim 25, wherein the request for access comprises an advertisement.

27. The method of claim 26, wherein the petitioner comprises a business.

28. The method of claim 27, wherein discriminating comprises deciding whether to patronize the petitioner.

29. An article of manufacture comprising a computer-readable memory containing data structures comprising:
a identifier module configured to receive a petition, extract a name corresponding to a source of the petition, and relay the name to a coupler;
a user interface configured to receive from a user, and relay to the coupler, a value selected from a rating scale;
the coupler configured to bind the name to the value; and
a database configured to receive and store the name and the value.

30. The article of claim 29 further comprising a query engine configured to retrieve from the database the value, when provided the name.

31. The system of claim 30, wherein the petition comprises an incoming call.

32. The article of claim 31, wherein the identifier module comprises a caller identification module.

33. The article of claim 32, wherein the name comprises the telephone number from which the incoming call originates.
